(19) United States
(12) Patent Application Publication
(10) Pub. No.: US 2026/0364990 A1
(43) Pub. Date: Nov. 19, 2026

(54) HEAT MANAGEMENT SYSTEM FOR VEHICLE

(71) Applicant: HANON SYSTEMS, Daejeon (KR)

(72) Inventors: Beom Seok JOO, Daejeon (KR); Seong Hun KIM, Daejeon (KR)

(21) Appl. No.: 19/133,793

(22) PCT Filed: Feb. 26, 2024
(86) PCT No.: PCT/KR2024/002445

§ 371 Date: May 29, 2025

(30) Foreign Application Priority Data
Mar. 20, 2023 (KR) 10-2023-0035687

(51) Int. Cl. B60H 1/00; B60H 1/14; B60H 1/32

(52) U.S. Cl. CPC B60H 1/00278; B60H 1/143; B60H 1/3227

(57) ABSTRACT

A heat management system for a vehicle may comprise: a compressor that compresses and circulates a first heat exchange medium; a first heat exchanger into which the compressed first heat exchange medium is introduced and which performs heat exchange with the first heat exchange medium; a second heat exchanger which performs heat exchange with air outside a vehicle interior; a third heat exchanger which is mounted in an air conditioning system and performs heat exchange with air that is discharged into the vehicle interior; a fourth heat exchanger which performs heat exchange with a second heat exchange medium in order to cool a battery; and a vapor injection module capable of introducing the first heat exchange medium in gaseous form into the compressor, wherein the vapor injection module comprises a plurality of expansion means and one gas-liquid separator.

### TECHNICAL FIELD

The present invention relates to a heat management system for a vehicle.

### BACKGROUND ART

A vehicle that uses a fuel cell and the like uses a heat pump in an air conditioning system as a heat source or has a separate heat source such as an electric heater to heat the interior of the vehicle.

The heat pump is a device that absorbs low-temperature heat and then moves the absorbed heat to a high-temperature place. The heat pump has a cycle in which a liquid refrigerant evaporates in an evaporator to become gas after taking heat from the surroundings, and the gas liquefies after emitting heat to the surroundings by a condenser. When the heat pump is applied to electric or hybrid vehicles, it is possible to secure a heat source that was lacking in the air conditioning system of the related art.

In a heat pump system in which a heat pump is disposed, a vapor injection system may be used to increase cooling and heating performance. Here, the vapor injection system has a structure in which in a refrigerant circulation system for cooling and heating, a gas-liquid separator is used, a refrigerant in a gas phase is introduced back into a compression unit, and the refrigerant in a liquid phase is supplied to an evaporator or a chiller for cooling a battery.

In this structure, the chiller may be connected to a branch pipe provided on a flow path connecting the gas-liquid separator and an outdoor unit, receive the refrigerant moving through the branch pipe, and perform heat exchange between the refrigerant and the cooling water passing through the interior of the battery.

However, since the vapor injection system has a structure in which the refrigerant does not move toward the chiller in a cooling mode, the battery is not cooled smoothly in the cooling mode, and thus battery performance cannot be maintained.

### DETAILED DESCRIPTION OF INVENTION

### Technical Problem

The present invention is devised to solve the above problems, and an object of an embodiment of the present invention is to provide a heat management system for a vehicle which is improved such that a refrigerant is supplied toward a chiller in a cooling mode for cooling a vehicle.

### Technical Solution

According to an embodiment of the present invention, there is provided a heat management system for a vehicle which includes: a compression unit that compresses a first heat exchange medium and circulates the compressed first heat exchange medium; a first heat exchanger that heats a vehicle interior by receiving the compressed first heat exchange medium; a second heat exchanger that performs heat exchange with air outside the vehicle interior; a third heat exchanger that is mounted in an air conditioning system and performs heat exchange with air discharged into the vehicle interior; a fourth heat exchanger that performs heat exchange with a second heat exchange medium to cool a battery; a gas-liquid separator that allows the first heat exchange medium in a gas phase to be introduced into the compression unit; and a branch unit that allows the first heat exchange medium in a liquid phase discharged from the gas-liquid separator to be introduced into the third heat exchanger or the fourth heat exchanger.

The heat management system for a vehicle may further include: a first expansion unit group that expands the first heat exchange medium passing through the first heat exchanger or the second heat exchanger in a cooling mode and a heating mode; and a second expansion unit group that expands the first heat exchange medium passing through the gas-liquid separator.

The first expansion unit group may include: a 1-1 expansion unit that expands the first heat exchange medium passing through the first heat exchanger in the heating mode; and a 1-2 expansion unit that expands the first heat exchange medium passing through the second heat exchanger in the cooling mode.

The second expansion unit group may include: a 2-1 expansion unit that secondarily expands the first heat exchange medium passing through the 1-1 expansion unit and the gas-liquid separator before passing through the second heat exchanger in the heating mode; a 2-2 expansion unit that secondarily expands the first heat exchange medium passing through the 1-2 expansion unit and the gas-liquid separator before passing through the third heat exchanger in the cooling mode; and a 2-3 expansion unit that secondarily expands the first heat exchange medium passing through the 1-2 expansion unit and the gas-liquid separator before passing through the fourth heat exchanger in the cooling mode.

In the cooling mode, the branch unit may branch the first heat exchange medium in a liquid phase separated in the gas-liquid separator toward the 2-2 expansion unit and the 2-3 expansion unit.

In the cooling mode, the first heat exchange medium passing through the branch unit may be secondarily expanded in the 2-2 expansion unit and then move to the compression unit via the third heat exchanger.

In the cooling mode, the first heat exchange medium passing through the branch unit may be secondarily expanded in the 2-3 expansion unit and then move to the compression unit via the fourth heat exchanger.

The branch unit may include: a 1-1 branch unit disposed between the first heat exchanger and the 1-1 expansion unit; a 1-2 branch unit disposed in one area of a flow path connecting the 1-1 expansion unit and the 2-3 expansion unit; a 1-3 branch unit that is connected to the gas-liquid separator and guides a direction of movement of the first heat exchange medium passing through the gas-liquid separator; a 1-4 branch unit disposed in one area of a flow path connecting the 1-2 expansion unit and the second heat exchanger; a 1-5 branch unit disposed in one area of a flow path connecting the 2-2 expansion unit and the 1-3 branch unit; and a 1-6 branch unit that guides a direction of movement of the first heat exchange medium passing through the third heat exchanger and the fourth heat exchanger.

In the heating mode, the 1-4 branch unit may guide the first heat exchange medium toward the 2-3 expansion unit.

In the cooling mode, the first heat exchange medium passing through the gas-liquid separator may pass through the 1-5 branch unit and the 2-2 expansion unit and then reach the third heat exchanger.

In the cooling mode, the first heat exchange medium passing through the gas-liquid separator may pass through the 1-5 branch unit and the 2-3 expansion unit and then reach the fourth heat exchanger.

The heat management system for a vehicle may further include a first bypass unit that is disposed between the fourth heat exchanger and the 2-3 expansion unit and bypasses the first heat exchange medium such that the first heat exchange medium passing through the 2-3 expansion unit does not pass through the fourth heat exchanger.

The branch unit may further include a 1-7 branch unit disposed in one area of a flow path connecting the fourth heat exchanger and the 1-6 branch unit.

The heat management system for a vehicle may further include a bypass flow path that connects the first bypass unit and the 1-7 branch unit and surrounds a part of the fourth heat exchanger, wherein the bypass flow path may guide the first heat exchange medium passing through the first bypass unit to the 1-7 branch unit.

The heat management system for a vehicle may further include: a fifth heat exchanger disposed between the 2-1 expansion unit and the second heat exchanger; and a second bypass unit that is disposed between the fourth heat exchanger and the fifth heat exchanger and guides a direction of movement of the first heat exchange medium such that the first heat exchange medium passing through the fifth heat exchanger does not pass through the fourth heat exchanger.

In addition, according to an embodiment of the present invention, there is provided a heat management system for a vehicle which includes: a compression unit that compresses a first heat exchange medium and circulates the compressed first heat exchange medium; a first heat exchanger into which the compressed first heat exchange medium is introduced and that performs heat exchange between air and the first heat exchange medium; a second heat exchanger that performs heat exchange with air outside a vehicle interior; a third heat exchanger that is mounted in an air conditioning system and performs heat exchange with air discharged into the vehicle interior; a fourth heat exchanger that performs heat exchange with a second heat exchange medium to cool a battery; and a vapor injection module that allows the first heat exchange medium in a gas phase to be introduced into the compression unit, wherein the vapor injection module includes: a gas-liquid separator that separates the first heat exchange medium into the first heat exchange medium in a gas phase and the first heat exchange medium in a liquid phase; a first expansion unit group that expands the first heat exchange medium passing through the first heat exchanger or the second heat exchanger in a cooling mode and a heating mode; and a second expansion unit group that expands the first heat exchange medium in a liquid phase passing through the gas-liquid separator, and in the cooling mode, the first heat exchange medium in a liquid phase separated in the gas-liquid separator is branched and moves to the third heat exchanger and the fourth heat exchanger.

The first expansion unit group may include a 1-1 expansion unit and a 1-2 expansion unit of a 2-way valve type, and the second expansion unit group may include a 2-1 expansion unit of a 3-way valve type, a 2-2 expansion unit of the 2-way valve type, and a 2-3 expansion unit of the 3-way valve type.

The 2-1 expansion unit may include: a first inlet through which the first heat exchange medium passing through the first heat exchanger is introduced; a second inlet through which the first heat exchange medium in a liquid phase passing through the gas-liquid separator is introduced; and a first outlet through which the first heat exchange medium introduced through the first inlet or the second inlet is discharged, the 2-3 expansion unit includes: a third inlet through which the first heat exchange medium passing through the second heat exchanger is introduced in the heating mode; a fourth inlet through which the first heat exchange medium in a liquid phase passing through the gas-liquid separator is introduced; and a second outlet through which the first heat exchange medium introduced through the third inlet or the fourth inlet is discharged, and the second outlet may be an outlet through which the first heat exchange medium is discharged toward the fourth heat exchanger.

### Advantageous Effects

According to embodiments of the present invention, a heat management system for a vehicle can have a structure in which a first heat exchange medium (refrigerant) that is discharged from a gas-liquid separator and introduced into a 1-5 branch unit is branched through the 1-5 branch unit and supplied toward a third heat exchanger (indoor heat exchanger) and a fourth heat exchanger (chiller). In particular, a first heat exchange medium can be heat-exchanged with a second heat exchange medium (cooling water) passing through a fourth heat exchanger to cool the second heat exchange medium. Accordingly, heat exchange occurs between a battery and a cooled second heat exchange medium, and thus it is possible to prevent the degradation of battery performance due to overheating of the battery during a cooling mode of a vehicle.

### DESCRIPTION OF DRAWINGS

FIG. 1 is a diagram illustrating a heat management system for a vehicle according to an embodiment of the present invention.

FIG. 2 is a diagram illustrating a cooling mode and a battery cooling mode of the heat management system for a vehicle in a vehicle cooling state.

FIG. 3 is a diagram illustrating the cooling mode of the heat management system for a vehicle in the vehicle cooling state.

FIG. 4 is a diagram illustrating the battery cooling mode of the heat management system for a vehicle in the vehicle cooling state.

FIG. 5 is a diagram illustrating a heating mode of the heat management system for a vehicle.

FIG. 6 is a diagram illustrating a dehumidification mode of the heat management system for a vehicle.

FIG. 7 is a diagram illustrating a heating mode of a heat management system for a vehicle according to another embodiment of the present invention.

FIG. 8 is a diagram illustrating a heating mode of a heat management system for a vehicle according to still another embodiment of the present invention.

FIG. 9 is a diagram illustrating a cooling mode of the heat management system for a vehicle of FIG. 8.

### MODES OF THE INVENTION

Hereinafter, exemplary embodiments of the present invention will be described in detail with reference to the accompanying drawings.

However, the technical spirit of the present invention is not limited to some of the described embodiments but may be implemented in various different forms, and one or more of the components among the embodiments may be used by being selectively coupled or substituted without departing from the scope of the technical spirit of the present invention.

In addition, terms (including technical and scientific terms) used in embodiments of the present invention may be interpreted as meanings that are generally understood by those skilled in the art to which the present invention pertains unless explicitly specifically defined and described, and the meanings of the commonly used terms, such as terms defined in a dictionary, may be interpreted in consideration of their contextual meanings in the related art.

In addition, the terms used in the embodiments of the present invention are for describing the embodiments and are not intended to limit the present invention.

In the specification, a singular form may include a plural form unless the context clearly dictates otherwise, and when described as “at least one (or one or more) of A, B, and C,” it may include one or more of all possible combinations of A, B, and C.

In addition, terms such as first, second, A, B, (a), and (b) may be used to describe components of the embodiments of the present invention.

These terms are only for the purpose of distinguishing one component from another component, and the nature, sequence, order, etc. of the components are not limited by these terms.

In addition, when a first component is described as being “connected,” “coupled,” or “joined” to a second component, it may include not only a case in which the first component is directly connected, coupled, or joined to the second component, but also a case in which the first component is “connected,” “coupled,” or “joined” to the second component with another component present between the first component and the second component.

In addition, when a first component is described as being formed or disposed on “on (above) or below (under)” a second component, “on (above)” or “below (under)” may include not only a case in which two components are in direct contact with each other, but also a case in which one or more other components are formed or disposed between the two components. In addition, when expressed as “on (above) or below (under),” it may include the meaning of not only an upward direction but also a downward direction based on one component.

Hereinafter, a heat management system for a vehicle will be described in detail with reference to the accompanying drawings, and the same or corresponding components are denoted by the same reference signs regardless of a drawing number, and overlapping descriptions thereof will be omitted.

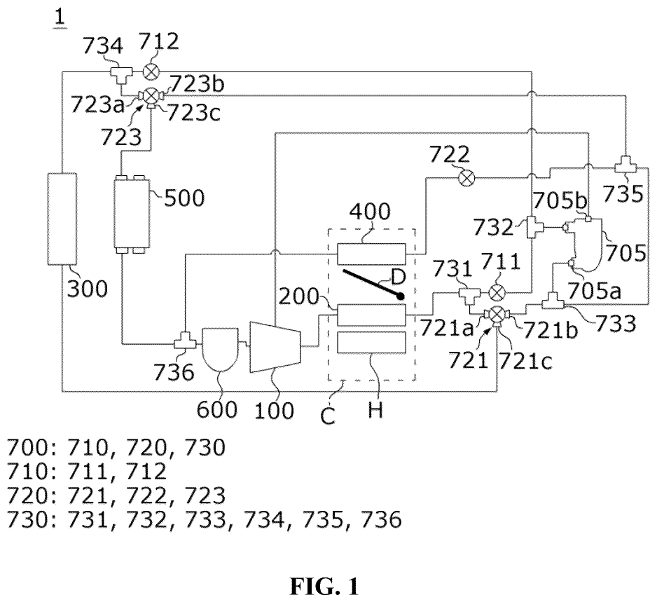

FIG. 1 is a diagram illustrating a heat management system for a vehicle according to an embodiment of the present invention.

Referring to FIG. 1, a heat management system 1 for a vehicle according to the embodiment of the present invention includes a compression unit 100 that compresses a first heat exchange medium and circulates the compressed first heat exchange medium, a first heat exchanger 200 into which the compressed first heat exchange medium is introduced and that performs heat exchange between air and the first heat exchange medium, a second heat exchanger 300 that performs heat exchange with air outside a vehicle interior, a third heat exchanger 400 that is mounted in an air conditioning system and performs heat exchange with air discharged into the vehicle interior, a fourth heat exchanger 500 that performs heat exchange with a second heat exchange medium to cool a battery, and a vapor injection module 700 that allows the first heat exchange medium in a gas phase to be introduced into the compression unit 100. Here, the first heat exchange medium may be called a refrigerant, and the second heat exchange medium may be called cooling water.

The compression unit 100 may compress the first heat exchange medium. The compression unit 100 may discharge the first heat exchange medium, which is compressed into a high temperature and high pressure gaseous state, toward the first heat exchanger 200. Therefore, the first heat exchange medium may circulate inside a heat exchange system for a vehicle. Here, the compression unit 100 may be called a compressor.

The first heat exchanger 200 may be disposed inside an air conditioning case C of the air conditioning device. The first heat exchanger 200 may perform heat exchange between air and the first heat exchange medium that is compressed by the compression unit 100 and introduced into the interior of the first heat exchanger 200. Therefore, the first heat exchanger 200 enables heating of the interior of a vehicle. Here, the first heat exchanger 200 may be called an indoor heat exchanger or a first condenser and may function as a condenser depending on an air conditioning mode. Additionally, the air that exchanges heat with the first heat exchange medium in the first heat exchanger 200 may be air that is introduced into the interior of the vehicle.

The second heat exchanger 300 may be installed in the front of the vehicle, perform heat exchange between the air that is introduced into the vehicle (the air outside the vehicle interior) and the first heat exchange medium, and discharge the heat from the first heat exchange medium to condense the first heat exchange medium. Here, the second heat exchanger 300 may be called an outdoor heat exchanger or a second condenser.

The third heat exchanger 400 may be installed inside the air conditioning case C of the air conditioning device. The third heat exchanger 400 may be supplied with the first heat exchange medium in a low-temperature and low-pressure state discharged from a 2-2 expansion unit 722 to be described below. In this case, the air flowing inside the air conditioning case C through a blower exchanges heat with the first heat exchange medium flowing inside the third heat exchanger 400 while passing through the third heat exchanger 400, is changed into cold air, and then is discharged into the vehicle interior to cool the vehicle interior. That is, the third heat exchanger 400 may induce heat exchange between the air discharged into the vehicle interior and the first heat exchange medium to cool the vehicle interior. Here, the third heat exchanger 400 may be called an evaporator.

In this case, the first heat exchanger 200 and the third heat exchanger 400 are both disposed inside the air conditioning case C to control the cooling and heating of the vehicle interior. In addition, a temperature control door D disposed inside the air conditioning case C may control the amount of air heat-exchanged through the first heat exchanger 200 and the third heat exchanger 400 to control the temperature of the vehicle interior.

The fourth heat exchanger 500 may be a heat exchanger that enables heat exchange between the first heat exchange medium passing through a 2-3 expansion unit 723 to be described below and the second heat exchange medium flowing through the interior of the fourth heat exchanger 500. The fourth heat exchanger 500 may be called a chiller. Since the first heat exchange medium exchanges heat with the second heat exchange medium in the fourth heat exchanger 500, the heat management system 1 for a vehicle may use the waste heat of the battery as a heat source.

An accumulation unit 600 may selectively discharge the first heat exchange medium in a liquid phase (a liquid state) or the first heat exchange medium in a gaseous phase (a gas state) from the first heat exchange medium that is introduced thereinto. The accumulation unit 600 may be called an accumulator. The accumulation unit 600 may be supplied with the first heat exchange medium passing through the third heat exchanger 400 or the first heat exchange medium passing through the fourth heat exchanger 500.

The vapor injection module 700 may control the movement direction of the first heat exchange medium depending on whether the first heat exchange medium is primarily expanded or secondarily expanded, the separation between the first heat exchange medium in a gas phase and the first heat exchange medium in a liquid phase, and the air conditioning mode.

The vapor injection module 700 may include a gas-liquid separator 705, a first expansion unit group 710, a second expansion unit group, and a plurality of first branch units 730.

The gas-liquid separator 705 may separate the first heat exchange medium introduced into the gas-liquid separator 705 into the first heat exchange medium in a gas phase and the first heat exchange medium in a liquid phase and discharge the first heat exchange medium separately.

The gas-liquid separator 705 may include an inlet through which the first heat exchange medium is introduced, a liquid outlet 705a through which the first heat exchange medium in a liquid phase is discharged, and a gas outlet 705b through which the first heat exchange medium in a gas phase is discharged.

The first expansion unit group 710 may control the movement and expansion of the first heat exchange medium passing through the first heat exchanger 200 or the second heat exchanger 300 in a cooling mode and a heating mode. The first expansion unit group 710 may include a 1-1 expansion unit 711 and a 1-2 expansion unit 712 of a 2-way valve type. The 1-1 expansion unit 711 may expand the first heat exchange medium passing through the first heat exchanger 200 in the heating mode. The 1-2 expansion unit 712 may expand the first heat exchange medium passing through the second heat exchanger 300 in the cooling mode. The 1-1 expansion unit 711 and the 1-2 expansion unit 712 may be electronic 2-way expansion valves.

The second expansion unit group 720 may control the movement and expansion of the first heat exchange medium passing through the gas-liquid separator 705. The second expansion unit group 720 may include a 2-1 expansion unit 721 of a 3-way valve type having two inlets and one outlet, a 2-2 expansion unit 722 of the 2-way valve type, and a 2-3 expansion unit 723 of the 3-way valve type having two inlets and one outlet.

The 2-1 expansion unit 721 may secondarily expand the first heat exchange medium passing through the 1-1 expansion unit 711 and the gas-liquid separator 705 before passing through the second heat exchanger 300 in the heating mode. The 2-1 expansion unit 721 may be disposed between a 1-1 branch unit 731 and a 1-3 branch unit 733 to be described below.

The 2-1 expansion unit 721 may include a first inlet 721a, a second inlet 721b, and a first outlet 721c. The first heat exchange medium passing through the first heat exchanger 200 may be introduced through the first inlet 721a. The first heat exchange medium in a liquid phase passing through the gas-liquid separator 705 may be introduced through the second inlet 721b. The first heat exchange medium introduced through the first inlet 721a or the second inlet 721b may be discharged through the first outlet 721c.

The 2-2 expansion unit 722 may secondarily expand the first heat exchange medium passing through the 1-2 expansion unit 712 and the gas-liquid separator 705 before passing through the third heat exchanger 400 in the cooling mode. The 2-2 expansion unit 722 may discharge the secondarily expanded first heat exchange medium toward the third heat exchanger 400.

The 2-3 expansion unit 723 may secondarily expand the first heat exchange medium passing through the 1-2 expansion unit 712 and the gas-liquid separator 705 before passing through the fourth heat exchanger 500 in the cooling mode. The 2-3 expansion unit 723 may be connected to the 1-2 expansion unit 712 in parallel by a 1-4 branch unit 734 to be described below.

The 2-3 expansion unit 723 may include a third inlet 723a, a fourth inlet 723b, and a second outlet 723c. The first heat exchange medium passing through the second heat exchanger 300 may be introduced through the third inlet 723a in the heating mode. The first heat exchange medium in a liquid phase passing through the gas-liquid separator 705 may be introduced through the fourth inlet 723b. The first heat exchange medium introduced through the third inlet 723a or the fourth inlet 723b may be discharged through the second outlet 723c. The first heat exchange medium may be discharged toward the fourth heat exchanger 500 through the second outlet 723c. Therefore, the secondarily expanded first heat exchange medium may be supplied to the fourth heat exchanger.

The plurality of first branch units 730 may be disposed on a flow path through which the first heat exchange medium passes. Here, the flow path may be a pipe having a hollow shape such that the first heat exchange medium may move through the pipe. The plurality of first branch units 730 may be provided in a “T” shape with three doorways. The plurality of first branch units 730 may include a 1-1 branch unit 731, a 1-2 branch unit 732, a 1-3 branch unit 733, a 1-4 branch unit 734, a 1-5 branch unit 735, and a 1-6 branch unit 736.

The 1-1 branch unit 731 may be disposed between the first heat exchanger 200 and the 1-1 expansion unit 711. The 1-1 branch unit 731 may be connected to the first heat exchanger 200 through the flow path disposed between the first heat exchanger 200 and the 1-1 branch unit 731, connected to the 1-1 expansion unit 711 through the flow path disposed between the 1-1 expansion unit 711 and the 1-1 branch unit 731, and connected to the first inlet 721a of the 2-1 expansion unit 721 through the flow path connecting the 2-1 expansion unit 721 and the 1-1 branch unit 731. The 1-1 branch unit 731 may guide the first heat exchange medium passing through the first heat exchanger 200 to the 1-1 expansion unit 711 or the 2-1 expansion unit 721.

The 1-2 branch unit 732 may be disposed in one area of the flow path connecting the 1-1 expansion unit 711 and the 2-3 expansion unit 723 and connected to the inlet of the gas-liquid separator 705 through the flow path disposed between the inlet of the gas-liquid separator 705 and the 1-2 branch unit 732. The 1-2 branch unit 732 may guide the first heat exchange medium that is primarily expanded through the 1-1 expansion unit 711 or the 1-2 expansion unit 712 to the gas-liquid separator 705.

The 1-3 branch unit 733 may be connected to the 2-1 expansion unit 721 through the flow path disposed between the 2-1 expansion unit 721 and the 1-3 branch unit 733, connected to the liquid outlet 705a of the gas-liquid separator 705 through the flow path connecting the liquid outlet 705a of the gas-liquid separator 705 and the 1-3 branch unit 733, and connected to the 1-5 branch unit 735 through the flow path connecting the 1-5 branch unit 735 and the 1-3 branch unit 733. The 1-3 branch unit 733 may guide the first heat exchange medium in a liquid phase passing through the gas-liquid separator 705 to the 1-5 branch unit 735 or the 2-1 expansion unit 721.

The 1-4 branch unit 734 may be disposed in one area of the flow path connecting the 1-2 expansion unit 712 and the second heat exchanger 300 and connected to the third inlet 723a of the 2-3 expansion unit 723 through the flow path connecting the 2-3 expansion unit 723 and the 1-4 branch unit 734. The 1-4 branch unit 734 may guide the first heat exchange medium passing through the second heat exchanger 300 to the 1-2 expansion unit 712 or the 2-3 expansion unit 723.

The outlet of the 1-4 branch unit 734 connected to the third inlet 723a of the 2-3 expansion unit 723 may be disposed on a side facing the fourth heat exchanger 500. Accordingly, in FIG. 1, the 2-3 expansion unit 723 may be disposed on a downstream side of the 1-1 expansion unit 711. Therefore, confusion about the flow path through which the first heat exchange medium moves can be prevented.

The 1-5 branch unit 735 may be disposed in one area of the flow path connecting the 2-2 expansion unit 722 and the 1-3 branch unit 733 and connected to the fourth inlet 723b of the 2-3 expansion unit 723 through the flow path connecting the 2-3 expansion unit 723 and the 1-5 branch unit 735.

In the cooling mode, the 1-5 branch unit 735 may branch the first heat exchange medium in a liquid phase separated in the gas-liquid separator 705 toward the 2-2 expansion unit 722 and the 2-3 expansion unit 723. That is, a portion of the 1-5 branch unit 735 connected to the 1-3 branch unit 733 may be an inlet, and portions of the 1-5 branch unit 735 connected to the 2-2 expansion unit 722 and the 2-3 expansion unit 723 may be outlets.

The 1-6 branch unit 736 may be disposed in one area of the flow path connecting the fourth heat exchanger 500 and the accumulation unit 600. Additionally, the 1-6 branch unit 736 may be connected to the third heat exchanger 400 through the flow path connecting the third heat exchanger 400 and the 1-6 branch unit 736. The 1-6 branch unit 736 may guide the first heat exchange medium passing through the third heat exchanger 400 or the fourth heat exchanger 500 toward the accumulation unit 600.

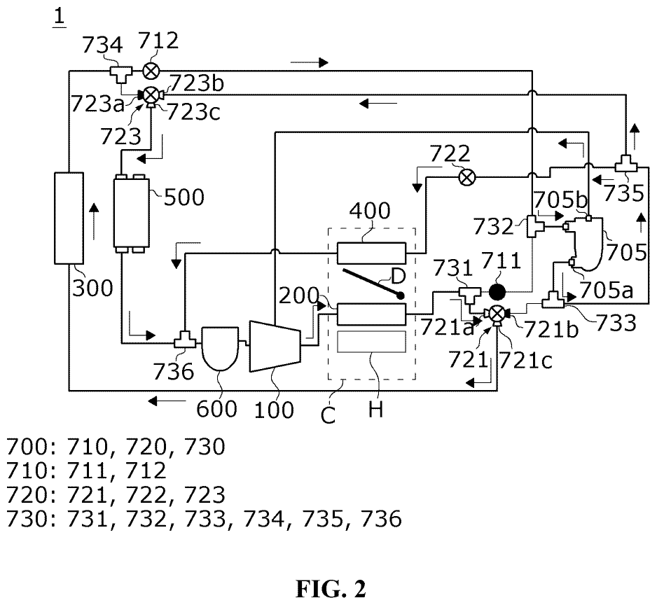

Hereinafter, the flow of the first heat exchange medium according to each mode of the heat management system 1 for a vehicle according to the embodiment of the present invention is described. The arrows shown in FIGS. 2 to 9 are symbols indicating the flow of the first heat exchange medium.

FIG. 2 is a diagram illustrating a cooling mode and a battery cooling mode of the heat management system for a vehicle in a vehicle cooling state.

Referring to FIGS. 1 and 2, when the heat management system 1 for a vehicle is operated simultaneously in the cooling mode and the battery cooling mode, the 1-1 expansion unit 711, the second inlet 721b of the 2-1 expansion unit 721, and the third inlet 723a of the 2-3 expansion unit 723 are closed. Accordingly, the first heat exchange medium passing through the first heat exchanger 200 passes through the 1-1 branch unit 731, the 2-1 expansion unit 721, the second heat exchanger 300, the 1-4 branch unit 734, the 1-2 expansion unit 712, and the 1-2 branch unit 732 and then is introduced into the gas-liquid separator 705. In this case, since the 1-1 expansion unit 711 is closed, the first heat exchange medium introduced into the 1-2 branch unit 732 may not move to the 1-1 branch unit 731 through the 1-1 expansion unit 711. In the above process, the first heat exchange medium is not expanded in the 2-1 expansion unit 721 but is primarily expanded while passing through the 1-2 expansion unit 712.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves to the outside of the gas-liquid separator 705 through the gas outlet 705b and then moves to the compression unit 100.

The first heat exchange medium in a liquid phase separated inside the gas-liquid separator 705 moves to the outside of the gas-liquid separator 705 through the liquid outlet 705a and then moves to the 1-5 branch unit 735 via the 1-3 branch unit 733. In this case, since the second inlet 721b of the 2-1 expansion unit 721 is closed, the first heat exchange medium introduced into the 1-3 branch unit 733 may remain in the flow path connecting the 2-1 expansion unit 721 and the 1-3 branch unit 733 or may be introduced again into the 1-3 branch unit 733 from the flow path connecting the 2-1 expansion unit 721 and the 1-3 branch unit 733 and then move to the 1-5 branch unit 735. The first heat exchange medium introduced into the 1-5 branch unit 735 is branched through two outlets of the 1-5 branch unit 735.

The first heat exchange medium branched through two outlets of the 1-5 branch unit 735 passes through the 2-2 expansion unit 722, the third heat exchanger 400, the 1-6 branch unit 736, and the accumulation unit 600 and then moves to the compression unit 100. In this case, the first heat exchange medium is secondarily expanded by the 2-2 expansion unit 722 and then moves toward the third heat exchanger 400.

Additionally, the first heat exchange medium passes through the 2-3 expansion unit 723, the fourth heat exchanger 500, the 1-6 branch unit 736, and the accumulation unit 600 and then moves to the compression unit 100. In this case, the first heat exchange medium is secondarily expanded by the 2-3 expansion unit 723 and then moves toward the fourth heat exchanger 500.

In this way, in the cooling mode of the heat management system 1 for a vehicle according to the embodiment of the present invention, the first heat exchange medium that passes through the second heat exchanger 300 and is primarily expanded may be secondarily expanded before passing through the third heat exchanger 400 or the fourth heat exchanger 500 after passing through the gas-liquid separator 705. In addition, in the cooling mode of the heat management system 1 for a vehicle according to the embodiment of the present invention, the first heat exchange medium in a liquid phase separated in the gas-liquid separator 705 may be branched and moved to the third heat exchanger 400 and the fourth heat exchanger 500.

More specifically, in the cooling mode, the first heat exchange medium passing through the 1-5 branch unit 735 may be secondarily expanded in the 2-2 expansion unit 722 and then move to the compression unit 100 through the third heat exchanger 400, and the first heat exchange medium passing through the 1-5 branch unit 735 may be secondarily expanded in the 2-3 expansion unit 723 and then move to the compression unit 100 via the fourth heat exchanger 500.

In particular, since the secondarily expanded first heat exchange medium may be supplied to the fourth heat exchanger 500, the heat management system 1 for a vehicle according to the embodiment of the present invention can improve the cooling performance of the second heat exchange medium passing through the fourth heat exchanger 500 compared to the heat management system 1 for a vehicle of the related art in which the first heat exchange medium could not be supplied to the fourth heat exchanger 500 in the cooling mode. Therefore, the battery can be cooled smoothly, and the lifetime of the battery can be maintained.

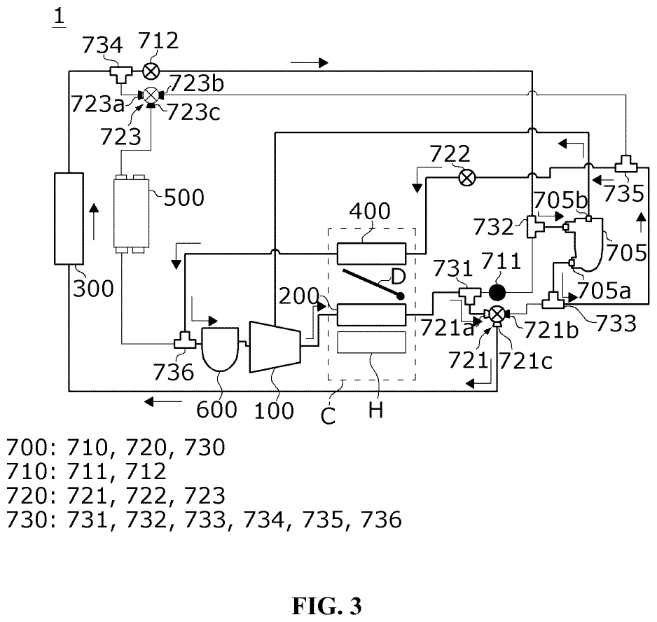

FIG. 3 is a diagram illustrating the cooling mode of the heat management system for a vehicle in the vehicle cooling state.

Referring to FIGS. 1 and 3, the cooling mode of the heat management system 1 for a vehicle may be a mode in which only cooling of the vehicle is operated.

In the case of the cooling mode of the heat management system 1 for a vehicle, the heat management system 1 for a vehicle of FIG. 2 is operated in only the cooling mode among the cooling mode and the battery cooling mode.

When the heat management system 1 for a vehicle is operated in the cooling mode, the 1-1 expansion unit 711, the second inlet 721b of the 2-1 expansion unit 721, and the third inlet 723a, the fourth inlet 723b, and the second outlet 723c of the 2-3 expansion unit 723 are closed. Accordingly, the first heat exchange medium passing through the first heat exchanger 200 passes through the 1-1 branch unit 731, the 2-1 expansion unit 721, the second heat exchanger 300, the 1-4 branch unit 734, the 1-2 expansion unit 712, and the 1-2 branch unit 732 and then is introduced into the gas-liquid separator 705. In this case, since the 1-1 expansion unit 711 is closed, the first heat exchange medium introduced into the 1-2 branch unit 732 may not move to the 1-1 branch unit 731 through the 1-1 expansion unit 711. In the above process, the first heat exchange medium is not expanded in the 2-1 expansion unit 721 but is primarily expanded while passing through the 1-2 expansion unit 712.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves to the outside of the gas-liquid separator 705 through the gas outlet 705b and then moves to the compression unit 100.

The first heat exchange medium in a liquid phase separated inside the gas-liquid separator 705 moves to the outside of the gas-liquid separator 705 through the liquid outlet 705a and then moves to the 1-5 branch unit 735 via the 1-3 branch unit 733. In this case, since the second inlet 721b of the 2-1 expansion unit 721 is closed, the first heat exchange medium introduced into the 1-3 branch unit 733 may remain in the flow path connecting the 2-1 expansion unit 721 and the 1-3 branch unit 733 or may be introduced again into the 1-3 branch unit 733 from the flow path connecting the 2-1 expansion unit 721 and the 1-3 branch unit 733 and then move to the 1-5 branch unit 735. The first heat exchange medium introduced into the 1-5 branch unit 735 is branched through two outlets of the 1-5 branch unit 735.

The first heat exchange medium branched through two outlets of the 1-5 branch unit 735 passes through the 2-2 expansion unit 722, the third heat exchanger 400, the 1-6 branch unit 736, and the accumulation unit 600 and then moves to the compression unit 100. In this case, the first heat exchange medium is secondarily expanded by the 2-2 expansion unit 722 and then moves toward the third heat exchanger 400.

In this case, since the third inlet 723a, the fourth inlet 723b, and the second outlet 723c of the 2-3 expansion unit 723 are all closed, even when the first heat exchange medium moves through the outlet of the 1-5 branch unit 735, the first heat exchange medium remains in the flow path connecting the 1-5 branch unit 735 and the 2-3 expansion unit 723 or is introduced again into the 1-5 branch unit 735 from the flow path connecting the 1-5 branch unit 735 and the 2-3 expansion unit 723 and moves toward the 2-2 expansion unit 722.

In this way, in the cooling mode of the heat management system 1 for a vehicle, the secondarily expanded first heat exchange medium may be heat-exchanged with the air while passing through the third heat exchanger 400.

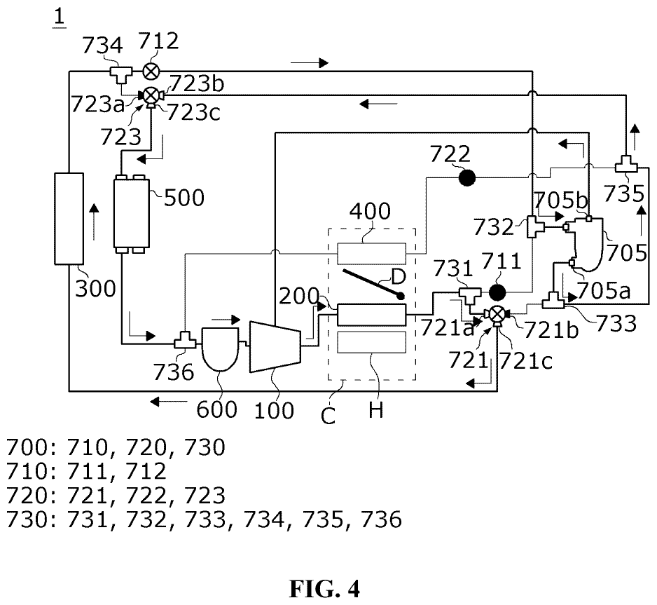

FIG. 4 is a diagram illustrating the battery cooling mode of the heat management system for a vehicle in the vehicle cooling state.

Referring to FIGS. 1 and 4, the battery cooling mode of the heat management system 1 for a vehicle may be a mode in which only battery cooling is required to be operated in a state in which cooling of the vehicle is not performed.

In the case of the battery cooling mode of the heat management system 1 for a vehicle, the heat management system 1 for a vehicle of FIG. 2 is operated in only the battery cooling mode among the cooling mode and the battery cooling mode.

When the heat management system 1 for a vehicle is operated in the battery cooling mode, the 1-1 expansion unit 711, the second inlet 721b of the 2-1 expansion unit 721, the 2-2 expansion unit 722, and the first inlet 721a of the 2-3 expansion unit 723 are closed. Accordingly, the first heat exchange medium passing through the first heat exchanger 200 passes through the 1-1 branch unit 731, the 2-1 expansion unit 721, the second heat exchanger 300, the 1-4 branch unit 734, the 1-2 expansion unit 712, and the 1-2 branch unit 732 and then is introduced into the gas-liquid separator 705. In this case, since the 1-1 expansion unit 711 is closed, the first heat exchange medium introduced into the 1-2 branch unit 732 may not move to the 1-1 branch unit 731 through the 1-1 expansion unit 711.

In the above process, the first heat exchange medium is not expanded in the 2-1 expansion unit 721 but is primarily expanded while passing through the 1-2 expansion unit 712.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves to the outside of the gas-liquid separator 705 through the gas outlet 705b and then moves to the compression unit 100.

The first heat exchange medium in a liquid phase separated inside the gas-liquid separator 705 moves to the outside of the gas-liquid separator 705 through the liquid outlet 705a and then moves toward the 1-5 branch unit 735 via the 1-3 branch unit 733. In this case, since the second inlet 721b of the 2-1 expansion unit 721 is closed, the first heat exchange medium introduced into the 1-3 branch unit 733 remains in the flow path connecting the 2-1 expansion unit 721 and the 1-3 branch unit 733 or is introduced again into the 1-3 branch unit 733 from the flow path connecting the 2-1 expansion unit 721 and the 1-3 branch unit 733 and then moves to the 1-5 branch unit 735. The first heat exchange medium introduced into the 1-5 branch unit 735 is branched through two outlets of the 1-5 branch unit 735.

The first heat exchange medium branched through two outlets of the 1-5 branch unit 735 passes through the 2-3 expansion unit 723, the fourth heat exchanger 500, the 1-6 branch unit 736, and the accumulation unit 600 and then moves to the compression unit 100. In this case, the first heat exchange medium is secondarily expanded by the 2-3 expansion unit 723 and then moves toward the fourth heat exchanger 500. In this case, since the third inlet 723a of the 2-3 expansion unit 723 is closed, the first heat exchange medium moving from the 1-5 branch unit 735 to the 2-3 expansion unit 723 may only be discharged through the second outlet 723c.

In this way, in the battery cooling mode of the heat management system 1 for a vehicle, the secondarily expanded first heat exchange medium may be heat-exchanged with the second heat exchange medium passing through the fourth heat exchanger 500 while the first heat exchange medium passes through the fourth heat exchanger 500.

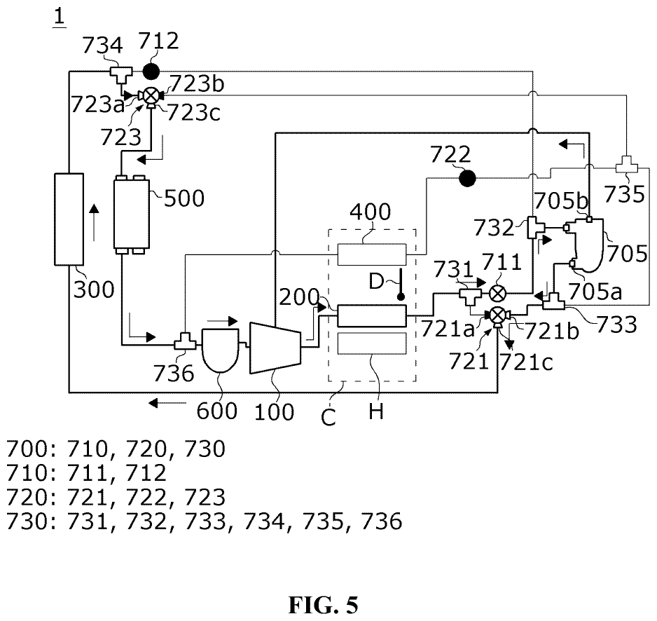

FIG. 5 is a diagram illustrating the heating mode of the heat management system for a vehicle.

Referring to FIGS. 1 and 5, when the heat management system 1 for a vehicle is operated in the heating mode, the first inlet 721a of the 2-1 expansion unit 721, the 1-1 expansion unit 711, the 2-2 expansion unit 722, and the fourth inlet 723b of the 2-3 expansion unit 723 are closed. Accordingly, the first heat exchange medium passing through the first heat exchanger 200 passes through the 1-1 branch unit 731, the 1-1 expansion unit 711, and the 1-2 branch unit 732 and then is introduced into the gas-liquid separator 705. In this case, since the first inlet 721a of the 2-1 expansion unit 721 is closed, the first heat exchange medium introduced into the 1-1 branch unit 731 may not move to the 2-1 expansion unit 721. In the above process, the first heat exchange medium is primarily expanded while passing through the 1-1 expansion unit 711.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves to the outside of the gas-liquid separator 705 through the gas outlet 705b and then moves to the compression unit 100.

The first heat exchange medium in a liquid phase separated inside the gas-liquid separator 705 moves to the outside of the gas-liquid separator 705 through the liquid outlet 705a, then passes through the 1-3 branch unit 733, the 2-1 expansion unit 721, the second heat exchanger 300, the 1-4 branch unit 734, the 2-3 expansion unit 723, the fourth heat exchanger 500, the 1-6 branch unit 736, and the accumulation unit 600, and then moves to the compression unit 100. In this case, the first heat exchange medium is secondarily expanded by the 2-2 expansion unit 722 and then moves to the third heat exchanger 400.

In this case, since the fourth inlet 723b of the 2-3 expansion unit 723 is closed, the first heat exchange medium introduced into the 1-3 branch unit 733 remains in the flow path connecting the 1-3 branch unit 733 and the 1-2 expansion unit 712 or moves from the flow path connecting the 1-3 branch unit 733 and the 1-2 expansion unit 712 to the 1-3 branch unit 733 and then moves toward the 2-3 expansion unit 723.

In this way, in the heating mode of the heat management system 1 for a vehicle, the secondarily expanded first heat exchange medium may be heat-exchanged with the second heat exchange medium passing through the fourth heat exchanger 500 while the first heat exchange medium passes through the fourth heat exchanger 500.

Meanwhile, in the heating mode of the heat management system 1 for a vehicle, a heater H may be driven. As a result, heated air may be introduced into the interior of the vehicle.

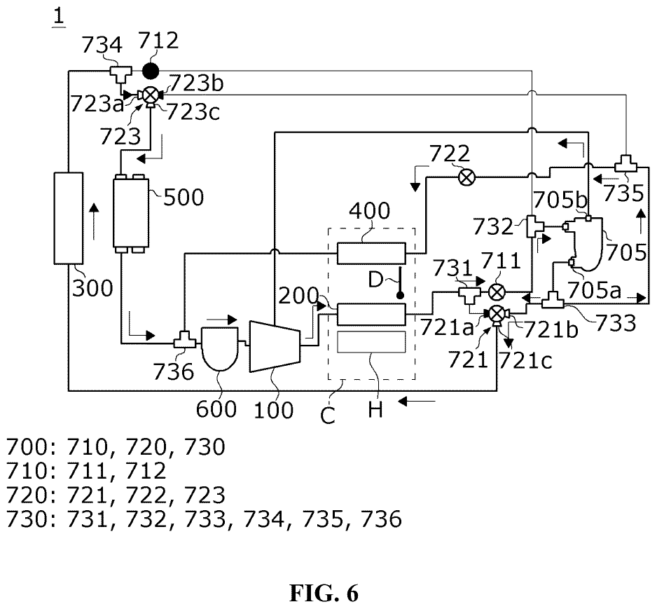

FIG. 6 is a diagram illustrating a dehumidification mode of the heat management system for a vehicle.

Referring to FIGS. 1 and 6, when the heat management system 1 for a vehicle is operated in the dehumidification mode, the first inlet 721a of the 2-1 expansion unit 721, the 1-2 expansion unit 712, and the fourth inlet 723b of the 2-3 expansion unit 723 are closed. Accordingly, the first heat exchange medium passing through the first heat exchanger 200 passes through the 1-1 branch unit 731, the 1-1 expansion unit 711, and the 1-2 branch unit 732 and then is introduced into the gas-liquid separator 705. In this case, since the first inlet 721a of the 2-1 expansion unit 721 is closed, the first heat exchange medium introduced into the 1-1 branch unit 731 may not move to the 2-1 expansion unit 721. In the above process, the first heat exchange medium is primarily expanded while passing through the 1-1 expansion unit 711.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves to the outside of the gas-liquid separator 705 through the gas outlet 705b and then moves to the compression unit 100.

The first heat exchange medium in a liquid phase separated inside the gas-liquid separator 705 moves to the outside of the gas-liquid separator 705 through the liquid outlet 705a and then moves to the 1-3 branch unit 733. The first heat exchange medium moved to the 1-3 branch unit 733 is branched through the 1-3 branch unit 733 to move toward the 2-1 expansion unit 721 and the 1-5 branch units 735.

First, the first heat exchange medium introduced into the 1-3 branch unit 733 passes through the 2-1 expansion unit 721, the second heat exchanger 300, the 1-4 branch unit 734, the 2-3 expansion unit 723, the fourth heat exchanger 500, 1-6 branch unit 736, and the accumulation unit 600 and then moves to the compression unit 100. In this case, the first heat exchange medium is secondarily expanded by the 2-1 expansion unit 721 and then moves toward the second heat exchanger 300.

In this case, since the fourth inlet 723b of the 2-3 expansion unit 723 is closed, the first heat exchange medium introduced into the 1-4 branch unit 734 remains in the flow path connecting the 1-4 branch unit 734 and the 1-2 expansion unit 712 or moves from the flow path connecting the 1-4 branch unit 734 and the 1-2 expansion unit 712 to the 1-4 branch unit 734 and then moves toward the 2-3 expansion unit 723. In this case, the first heat exchange medium passing through the 2-3 expansion unit 723 passes through the 2-3 expansion unit 723 without being expanded.

Next, the first heat exchange medium introduced into the 1-3 branch unit 733 passes through the 1-5 branch unit 735, the 2-2 expansion unit, the third heat exchanger 400, the 1-6 branch unit 736, and the accumulation unit 600 and then moves to the compression unit 100. In this case, the first heat exchange medium is secondarily expanded by the 2-2 expansion unit 722 and then moves toward the third heat exchanger 400.

In this way, in the dehumidification mode of the heat management system 1 for a vehicle, the secondarily expanded first heat exchange medium may be heat-exchanged with the air passing through the third heat exchanger 400 while the first heat exchange medium passes through the third heat exchanger 400. Additionally, in the dehumidification mode, the secondarily expanded first heat exchange medium may be heat-exchanged with the second heat exchange medium passing through the fourth heat exchanger 500 while passing through the fourth heat exchanger 500.

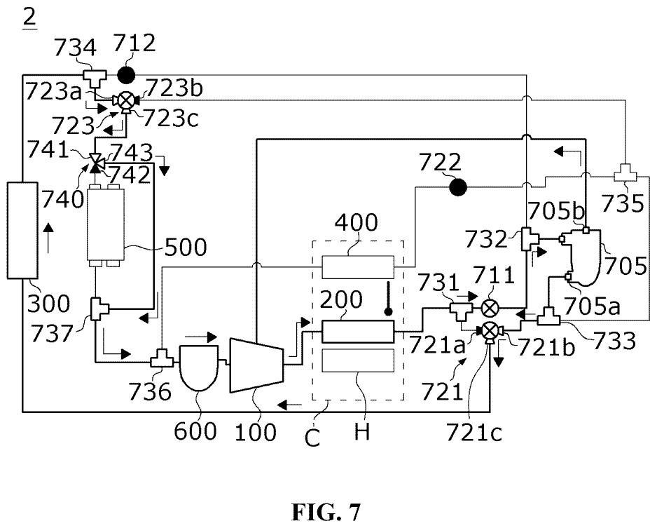

FIG. 7 is a diagram illustrating a heating mode of a heat management system for a vehicle according to another embodiment of the present invention.

When describing a heat management system 2 for a vehicle according to FIG. 7, the same components as those of the heat management system 1 for a vehicle according to the embodiment of the present invention are designated by the same reference signs, and a description thereof will be omitted.

Referring to FIGS. 1 and 7, a vapor injection module 700 of the heat management system 2 for a vehicle according to another embodiment of the present invention may further include a 1-7 branch unit 737 and a second branch unit 740.

The 1-7 branch unit 737 may be disposed on a downstream side of the fourth heat exchanger 500 in FIG. 7. The 1-7 branch unit 737 may be disposed in one area of the flow path connecting the fourth heat exchanger 500 and the 1-6 branch unit 736 and connected to the second branch unit 740 through the flow path connecting the second branch unit 740 and the 1-7 branch unit 737.

The second branch unit 740 may be disposed between the fourth heat exchanger 500 and the 2-3 expansion unit 723. The second branch unit 740 may include a fifth inlet 741, a third outlet 742, and a fourth outlet 743. The first heat exchange medium passing through the 2-3 expansion unit 723 may be introduced through the fifth inlet 741. The first heat exchange medium introduced through the fifth inlet 741 may be discharged through the third outlet 742 and the fourth outlet 743. The third outlet 742 may be connected to the fourth heat exchanger 500 through the flow path.

The fourth outlet 743 may be connected to the 1-7 branch unit 737 through a bypass flow path. In this case, the bypass flow path may have a shape that surrounds a part of the fourth heat exchanger 500. Accordingly, the second branch unit 740 may cause the first heat exchange medium to bypass the fourth heat exchanger 500 through the bypass flow path such that the first heat exchange medium passing through the 2-3 expansion unit 723 does not pass through the fourth heat exchanger 500. In this way, the second branch unit 740 is a unit causing the first heat exchange medium to bypass the fourth heat exchanger 500, and the second branch unit 740 may be a first bypass unit.

When the heat management system 2 for a vehicle according to another embodiment of the present invention is operated in the heating mode, the first inlet 721a of the 2-1 expansion unit 721, the 1-2 expansion unit 712, the 2-2 expansion unit 722, the fourth inlet 723b of the 2-3 expansion unit 723, and the third outlet 742 of the second branch unit 740 are closed. Accordingly, the first heat exchange medium passing through the first heat exchanger 200 passes through the 1-1 branch unit 731, the 1-1 expansion unit 711, and the 1-2 branch unit 732 and then is introduced into the gas-liquid separator 705. In this case, since the first inlet 721a of the 2-1 expansion unit 721 is closed, the first heat exchange medium introduced into the 1-1 branch unit 731 may not move to the 2-1 expansion unit 721.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves to the outside of the gas-liquid separator 705 through the gas outlet 705b and then moves to the compression unit 100.

The first heat exchange medium in a liquid phase separated inside the gas-liquid separator 705 moves to the outside of the gas-liquid separator 705 through the liquid outlet 705a, then passes through the 1-3 branch unit 733, the 2-1 expansion unit 721, the second heat exchanger 300, the 1-4 branch unit 734, the 2-3 expansion unit 723, the second branch unit 740, the bypass flow path, the 1-7 branch unit 737, the 1-6 branch unit 736, and the accumulation unit 600, and then moves to the compression unit 100.

In this case, since the fourth inlet 723b of the 2-3 expansion unit 723 is closed, the first heat exchange medium moved to the outside of the 1-3 branch unit 733 remains in the flow path disposed between the 1-3 branch unit 733, the 1-5 branch unit 735, and the 2-3 expansion unit 723 or moves from the flow path disposed between the 1-3 branch unit 733, the 1-5 branch unit 735, and the 2-3 expansion unit 723 to the 1-3 branch unit 733 and then moves toward the 2-1 expansion unit 721.

In addition, since the 2-2 expansion unit 722 is closed, the first heat exchange medium moved to the outside of the 1-3 branch unit 733 remains in the flow path connecting the 1-3 branch unit 733 and the 2-2 expansion unit 722 or moves from the flow path connecting the 1-3 branch unit 733 and 2-2 expansion unit 722 to the 1-3 branch unit 733 and then moves toward the 2-1 expansion unit 721.

In this way, the heat management system 2 for a vehicle according to another embodiment of the present invention may be designed such that the first heat exchange medium bypasses the fourth heat exchanger 500 in the heating mode. Therefore, when battery cooling is not desired in the heating mode, the heat management system 2 for a vehicle according to another embodiment of the present invention may cause the first heat exchange medium to bypass the fourth heat exchanger 500 such that the first heat exchange medium does not pass through the fourth heat exchanger 500.

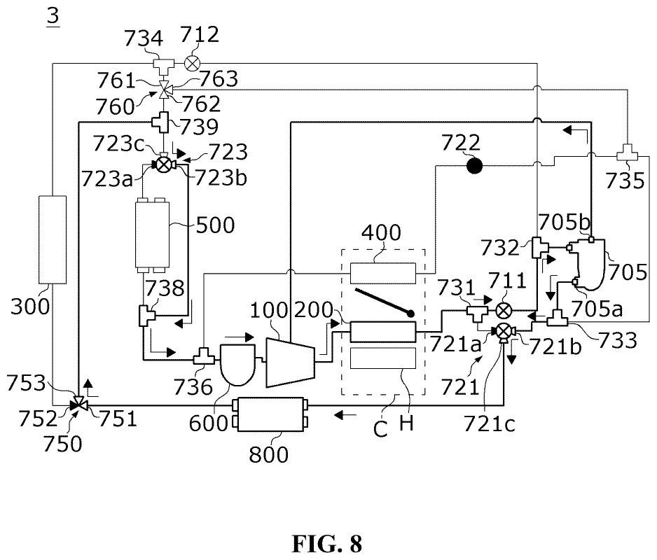

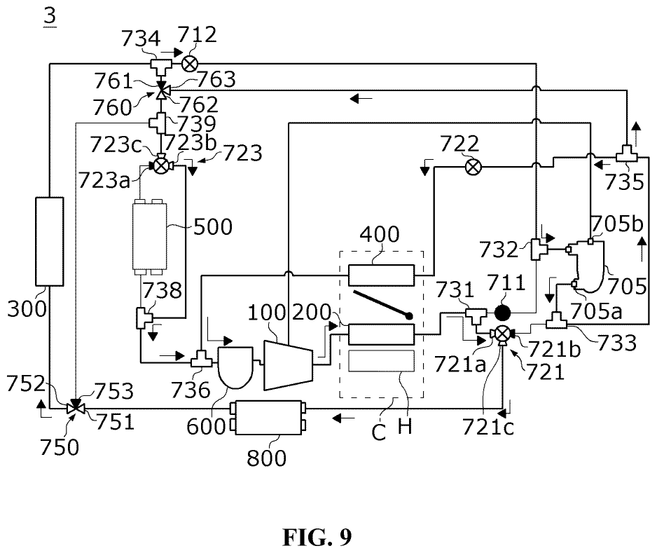

FIG. 8 is a diagram illustrating a heating mode of a heat management system for a vehicle according to still another embodiment of the present invention, and FIG. 9 is a diagram illustrating a cooling mode of the heat management system for a vehicle of FIG. 8.

When describing a heat management system 3 for a vehicle according to FIGS. 8 and 9, the same components as those of the heat management system 1 for a vehicle according to the embodiment of the present invention are designated by the same reference signs, and a description thereof will be omitted.

Referring to FIGS. 1 and 8, the heat management system 3 for a vehicle according to still another embodiment of the present invention further includes a fifth heat exchanger 800, and the vapor injection module 700 may further include a 1-8 branch unit 738, a 1-9 branch unit 739, a third branch unit 750, and a fourth branch unit 760.

The fifth heat exchanger 800 may be disposed between the 2-1 expansion unit 721 and the second heat exchanger 300. More specifically, the fifth heat exchanger 800 may be disposed in one area of the flow path connecting the 2-1 expansion unit 721 and the second heat exchanger 300. The fifth heat exchanger 800 may be a water condenser.

The 1-8 branch unit 738 may be disposed on a downstream side of the fourth heat exchanger 500 in FIGS. 8 and 9. The 1-8 branch unit 738 may be disposed in one area of the flow path connecting the fourth heat exchanger 500 and the 1-6 branch unit 736 and connected to the second branch unit 740 through the flow path connecting the 2-3 expansion unit 723 and the 1-7 branch unit 737.

The 1-9 branch unit 739 may be disposed between the 2-3 expansion unit 723 and the fourth branch unit 760 in FIGS. 8 and 9. The 1-9 branch unit 739 may be disposed in one area of the flow path connecting the 2-3 expansion unit 723 and the fourth branch unit 760 and connected to the third branch unit 750 through the flow path connecting the third branch unit 750 and the 1-9 branch unit 739.

The third branch unit 750 may be disposed between the fourth heat exchanger 500 and the fifth heat exchanger 800. More specifically, the third branch unit 750 may be disposed in one area of the flow path connecting the fourth heat exchanger 500 and the fifth heat exchanger 800, and the third branch unit 750 may be connected to the 1-9 branch unit 739 through the flow path connecting the 1-9 branch unit 739 and the third branch unit 750. The third branch unit 750 may guide a direction of movement of the first heat exchange medium such that the first heat exchange medium passing through the fifth heat exchanger 800 does not pass through the fourth heat exchanger 500.

The third branch unit 750 may include a sixth inlet 751, a fifth outlet 752, and a sixth outlet 753. The first heat exchange medium passing through the fifth heat exchanger 800 may be introduced through the sixth inlet 751. The first heat exchange medium introduced through the sixth inlet 751 may be discharged through the fifth outlet 752 and the sixth outlet 753. In this way, the third branch unit 750 is a unit causing the first heat exchange medium to bypass the fourth heat exchanger 500, and the third branch unit 750 may be a second bypass unit.

The fourth branch unit 760 may be disposed behind the 2-3 expansion unit 723 along the flow of the first heat exchange medium in the cooling mode. More specifically, the fourth branch unit 760 may be disposed between the 1-4 branch unit 734 and the 1-9 branch unit 739. The fourth branch unit 760 may be disposed in one area of the flow path connecting the 1-4 branch unit 734 and the 1-9 branch unit 739 and connected to the 1-5 branch unit 735 through the flow path connecting the 1-5 branch unit 735 and the fourth branch unit 760. The fourth branch unit 760 may guide the first heat exchange medium such that the first heat exchange medium passing through the 1-5 branch unit 735 moves toward the 2-3 expansion unit 723.

The fourth branch unit 760 may include a seventh inlet 761, a seventh outlet 762, and an eighth inlet 763. The first heat exchange medium passing through the 1-4 branch unit 734 may be introduced through the seventh inlet 761. The first heat exchange medium introduced through the seventh inlet 761 and the eighth inlet 763 may be discharged through the seventh outlet 762. The first heat exchange medium passing through the 1-5 branch unit may be introduced through the eighth inlet 763.

The fourth inlet 723b of the 2-3 expansion unit 723 may be connected to the 1-8 branch unit 738 through a bypass flow path. In this case, the bypass flow path may have a shape that surrounds a part of the fourth heat exchanger 500. Accordingly, the second branch unit 740 may cause the first heat exchange medium to bypass the fourth heat exchanger 500 through the bypass flow path such that the first heat exchange medium passing through the 2-3 expansion unit 723 does not pass through the fourth heat exchanger 500.

When the heat management system 3 for a vehicle according to still another embodiment of the present invention is operated in the heating mode, the first inlet 721a of the 2-1 expansion unit 721, the 2-2 expansion unit 722, the third inlet 723a of the 2-3 expansion unit 723, and the fifth outlet 752 of the third branch unit 750 are closed. Accordingly, the first heat exchange medium passing through the first heat exchanger 200 passes through the 1-1 branch unit 731, the 1-1 expansion unit 711, and the 1-2 branch unit 732 and then is introduced into the gas-liquid separator 705. In this case, since the first inlet 721a of the 2-1 expansion unit 721 is closed, the first heat exchange medium introduced into the 1-1 branch unit 731 may not move to the 2-1 expansion unit 721.

The first heat exchange medium introduced into the gas-liquid separator 705 is separated into the first heat exchange medium in a gas phase and the first heat exchange medium in a liquid phase inside the gas-liquid separator 705.

The first heat exchange medium in a gas phase separated inside the gas-liquid separator 705 moves from the outside of the gas-liquid separator 705 to the compression unit 100 through the gas outlet 705b.

The first heat exchange medium in a liquid phase separated inside the gas-liquid separator 705 moves to the outside of the gas-liquid separator 705 through the liquid outlet 705a, then passes through the 1-3 branch unit 733, the 2-1 expansion unit 721, the fifth heat exchanger 800, the third branch unit 750, the 1-9 branch unit 739, the 2-3 expansion unit 723, the bypass flow path, the 1-8 branch unit 738, the 1-6 branch unit 736, and the accumulation unit 600, and then moves to the compression unit 100.

In this way, in the heating mode of the heat management system 3 for a vehicle according to still another embodiment of the present invention, when the fifth heat exchanger 800 is used instead of the second heat exchanger 300, the flow of the first heat exchange medium may be controlled through the third branch unit 750 such that the first heat exchange medium does not move toward the second heat exchanger 300.

In addition, the heat management system 3 for a vehicle according to still another embodiment of the present invention may be designed such that the first heat exchange medium bypasses the fourth heat exchanger 500 in the heating mode. Therefore, when battery cooling is not desired in the heating mode, the heat management system 3 for a vehicle according to still another embodiment of the present invention may cause the first heat exchange medium to bypass the fourth heat exchanger 500 such that the first heat exchange medium does not pass through the fourth heat exchanger 500.

Referring to FIGS. 1, 8, and 9, when the heat management system 3 for a vehicle according to another embodiment of the present invention is operated in the cooling mode, the 1-1 expansion unit 711, the second inlet 721b of the 2-1 expansion unit 721, the fifth outlet 752 of the third branch unit 750, the seventh inlet 761 of the fourth branch unit 760, and the third inlet 723a of the 2-3 expansion unit 723. Accordingly, the first heat exchange medium passing through the first heat exchanger 200 passes through the 1-1 branch unit 731, the 2-1 expansion unit 721, the fifth heat exchanger 800, the second heat exchanger 300, the 1-4 branch unit 734, the 1-2 expansion unit 712, and the 1-2 branch unit 732 and then is introduced into the gas-liquid separator 705. In this case, since the second inlet 721b of the 2-1 expansion unit 721 is closed, the first heat exchange medium introduced into the 1-1 branch unit 731 may not move to the 1-1 expansion unit 711.

The first heat exchange medium introduced into the gas-liquid separator 705 is separated into the first heat exchange medium in a gas phase and the first heat exchange medium in a liquid phase inside the gas-liquid separator 705.

The first heat exchange medium in a liquid phase separated inside the gas-liquid separator 705 moves to the outside of the gas-liquid separator 705 through the liquid outlet 705a and then moves to the 1-5 branch unit 735 via the 1-3 branch unit 733. In this case, since the second inlet 721b of the 2-1 expansion unit 721 is closed, the first heat exchange medium introduced into the 1-3 branch unit 733 may not be introduced to the 2-1 expansion unit 721. The first heat exchange medium introduced into the 1-5 branch unit 735 is branched through two outlets of the 1-5 branch unit 735.

The first heat exchange medium branched through two outlets of the 1-5 branch unit 735 passes through the 2-2 expansion unit 722, the third heat exchanger 400, the 1-6 branch unit 736, and the accumulation unit 600 and then moves to the compression unit 100.

Additionally, the first heat exchange medium passes through the 1-9 branch unit 739, the 2-3 expansion unit 723, the bypass flow path, the 1-8 branch unit 738, the 1-6 branch unit 736, and the accumulation unit 600 and then moves to the compression unit 100.

In this way, the heat management system 3 for a vehicle according to still another embodiment of the present invention may be designed such that the first heat exchange medium bypasses the fourth heat exchanger 500 in the cooling mode. Therefore, when battery cooling is not desired in the heating mode, the heat management system 3 for a vehicle according to still another embodiment of the present invention may cause the first heat exchange medium to bypass the fourth heat exchanger 500 such that the first heat exchange medium does not pass through the fourth heat exchanger 500.

[Reference Signs List]

| | |
|---|---|
| 1, 2, 3: Heat management system for | 100: Compression unit |
| vehicle | |
| 200: First heat exchanger | 300: Second heat exchanger |
| 400: Third heat exchanger | 500: Fourth heat exchanger |
| 600: Accumulation unit | 700: Vapor Injection Module |
| 705: Gas-liquid separator | 705a: Liquid outlet |
| 705b: Gas outlet | 710: First expansion unit group |
| 711: 1-1 expansion unit | 712: 1-2 expansion unit |
| 720: Second expansion unit group | 721: 2-1 expansion unit |
| 721a: First inlet | 721b: Second inlet |
| 721c: First outlet | 722: 2-2 expansion unit |
| 723: 2-3 expansion unit | 723a: Third inlet |
| 723b: Fourth inlet | 723c: Second outlet |
| 730: Plurality of first branch unit | 731: 1-1 branch unit |
| 732: 1-2 branch unit | 733: 1-3 branch unit |
| 734: 1-4 branch unit | 735: 1-5 branch unit |
| 736: 1-6 branch unit | 737: 1-7 branch unit |
| 738: 1-8 branch unit | 739: 1-9 branch unit |
| 740: Second branch unit | 741: Fifth inlet |
| 742: Third outlet | 743: Fourth outlet |
| 750: Third branch unit | 751: Sixth inlet |
| 752: Fifth outlet | 753: Sixth outlet |
| 760: Fourth branch unit | 761: Seventh inlet |
| 762: Seventh outlet | 763: Eighth inlet |
| 800: Fifth heat exchanger | C: Air conditioning |
| D: Temperature control door | H: Heater |

1. A heat management system for a vehicle, comprising:
a compression unit that compresses a first heat exchange medium and circulates the compressed first heat exchange medium;
a first heat exchanger that heats a vehicle interior by receiving the compressed first heat exchange medium;
a second heat exchanger that performs heat exchange with air outside the vehicle interior;
a third heat exchanger that is mounted in an air conditioning system and performs heat exchange with air discharged into the vehicle interior;
a fourth heat exchanger that performs heat exchange with a second heat exchange medium to cool a battery;
a gas-liquid separator that allows the first heat exchange medium in a gas phase to be introduced into the compression unit; and
a branch unit that allows the first heat exchange medium in a liquid phase discharged from the gas-liquid separator to be introduced into the third heat exchanger or the fourth heat exchanger.

2. The heat management system for a vehicle of claim 1, further comprising:
a first expansion unit group that expands the first heat exchange medium passing through the first heat exchanger or the second heat exchanger in a cooling mode and a heating mode; and
a second expansion unit group that expands the first heat exchange medium passing through the gas-liquid separator.

3. The heat management system for a vehicle of claim 2, wherein the first expansion unit group includes:
a 1-1 expansion unit that expands the first heat exchange medium passing through the first heat exchanger in the heating mode; and
a 1-2 expansion unit that expands the first heat exchange medium passing through the second heat exchanger in the cooling mode.

4. The heat management system for a vehicle of claim 3, wherein the second expansion unit group includes:
a 2-1 expansion unit that secondarily expands the first heat exchange medium passing through the 1-1 expansion unit and the gas-liquid separator before passing through the second heat exchanger in the heating mode;
a 2-2 expansion unit that secondarily expands the first heat exchange medium passing through the 1-2 expansion unit and the gas-liquid separator before passing through the third heat exchanger in the cooling mode; and
a 2-3 expansion unit that secondarily expands the first heat exchange medium passing through the 1-2 expansion unit and the gas-liquid separator before passing through the fourth heat exchanger in the cooling mode.

5. The heat management system for a vehicle of claim 4, wherein, in the cooling mode, the branch unit branches the first heat exchange medium in a liquid phase separated in the gas-liquid separator toward the 2-2 expansion unit and the 2-3 expansion unit.

6. The heat management system for a vehicle of claim 5, wherein, in the cooling mode, the first heat exchange medium passing through the branch unit is secondarily expanded in the 2-2 expansion unit and then moves to the compression unit via the third heat exchanger.

7. The heat management system for a vehicle of claim 5, wherein, in the cooling mode, the first heat exchange medium passing through the branch unit is secondarily expanded in the 2-3 expansion unit and then moves to the compression unit via the fourth heat exchanger.

8. The heat management system for a vehicle of claim 4, wherein the branch unit includes:
a 1-1 branch unit disposed between the first heat exchanger and the 1-1 expansion unit;
a 1-2 branch unit disposed in one area of a flow path connecting the 1-1 expansion unit and the 2-3 expansion unit;
a 1-3 branch unit that is connected to the gas-liquid separator and guides a direction of movement of the first heat exchange medium passing through the gas-liquid separator;
a 1-4 branch unit disposed in one area of a flow path connecting the 1-2 expansion unit and the second heat exchanger;
a 1-5 branch unit disposed in one area of a flow path connecting the 2-2 expansion unit and the 1-3 branch unit; and
a 1-6 branch unit that guides a direction of movement of the first heat exchange medium passing through the third heat exchanger and the fourth heat exchanger.

9. The heat management system for a vehicle of claim 8, wherein, in the heating mode, the 1-4 branch unit guides the first heat exchange medium toward the 2-3 expansion unit.

10. The heat management system for a vehicle of claim 8, wherein, in the cooling mode, the first heat exchange medium passing through the gas-liquid separator passes through the 1-5 branch unit and the 2-2 expansion unit and then reaches the third heat exchanger.

11. The heat management system for a vehicle of claim 8, wherein, in the cooling mode, the first heat exchange medium passing through the gas-liquid separator passes through the 1-5 branch unit and the 2-3 expansion unit and then reaches the fourth heat exchanger.

12. The heat management system for a vehicle of claim 5, further comprising a first bypass unit that is disposed between the fourth heat exchanger and the 2-3 expansion unit and bypasses the first heat exchange medium such that the first heat exchange medium passing through the 2-3 expansion unit does not pass through the fourth heat exchanger.

13. The heat management system for a vehicle of claim 12, wherein the branch unit further includes a 1-7 branch unit disposed in one area of a flow path connecting the fourth heat exchanger and the 1-6 branch unit.

14. The heat management system for a vehicle of claim 13, further comprising a bypass flow path that connects the first bypass unit and the 1-7 branch unit and surrounds a part of the fourth heat exchanger,
wherein the bypass flow path guides the first heat exchange medium passing through the first bypass unit to the 1-7 branch unit.

15. The heat management system for a vehicle of claim 5, further comprising:
a fifth heat exchanger disposed between the 2-1 expansion unit and the second heat exchanger; and
a second bypass unit that is disposed between the fourth heat exchanger and the fifth heat exchanger and guides a direction of movement of the first heat exchange medium such that the first heat exchange medium passing through the fifth heat exchanger does not pass through the fourth heat exchanger.

16. A heat management system for a vehicle, comprising:
a compression unit that compresses a first heat exchange medium and circulates the compressed first heat exchange medium;
a first heat exchanger into which the compressed first heat exchange medium is introduced and that performs heat exchange with the first heat exchange medium;
a second heat exchanger that performs heat exchange with air outside a vehicle interior;
a third heat exchanger that is mounted in an air conditioning system and performs heat exchange with air discharged into the vehicle interior;
a fourth heat exchanger that performs heat exchange with a second heat exchange medium to cool a battery; and
a vapor injection module that allows the first heat exchange medium in a gas phase to be introduced into the compression unit,
wherein the vapor injection module includes:
a gas-liquid separator that separates the first heat exchange medium into the first heat exchange medium in a gas phase and the first heat exchange medium in a liquid phase;
a first expansion unit group that expands the first heat exchange medium passing through the first heat exchanger or the second heat exchanger in a cooling mode and a heating mode; and
a second expansion unit group that expands the first heat exchange medium in a liquid phase passing through the gas-liquid separator, and
in the cooling mode, the first heat exchange medium in a liquid phase separated in the gas-liquid separator is branched and moves to the third heat exchanger and the fourth heat exchanger.

17. The heat management system for a vehicle of claim 16, wherein the first expansion unit group includes a 1-1 expansion unit and a 1-2 expansion unit of a 2-way valve type, and
the second expansion unit group includes a 2-1 expansion unit of a 3-way valve type, a 2-2 expansion unit of the 2-way valve type, and a 2-3 expansion unit of the 3-way valve type.

18. The heat management system for a vehicle of claim 17, wherein the 2-1 expansion unit includes:
a first inlet through which the first heat exchange medium passing through the first heat exchanger is introduced;
a second inlet through which the first heat exchange medium in a liquid phase passing through the gas-liquid separator is introduced; and
a first outlet through which the first heat exchange medium introduced through the first inlet or the second inlet is discharged,
the 2-3 expansion unit includes:
a third inlet through which the first heat exchange medium passing through the second heat exchanger is introduced in the heating mode;
a fourth inlet through which the first heat exchange medium in a liquid phase passing through the gas-liquid separator is introduced; and
a second outlet through which the first heat exchange medium introduced through the third inlet or the fourth inlet is discharged, and
the second outlet is an outlet through which the first heat exchange medium is discharged toward the fourth heat exchanger.
